(19) United States
(12) Patent Application Publication
(10) Pub. No.: US 2026/0187494 A1
(43) Pub. Date: Jul. 2, 2026

(54) KNOWLEDGE EXTRACTION SYSTEM AND KNOWLEDGE EXTRACTION METHOD

(71) Applicant: Hitachi, Ltd., Tokyo (JP)

(72) Inventors: Shintaro SUZUKI, Tokyo (JP); Akihiko HYODO, Tokyo (JP); Hidenori SAKANIWA, Tokyo (JP)

(21) Appl. No.: 19/429,742

(22) Filed: Dec. 22, 2025

(30) Foreign Application Priority Data
Dec. 27, 2024 (JP) 2024-232195

(51) Int. Cl. G06N 5/022; G06F 16/35; G06F 40/35

(52) U.S. Cl. CPC G06N 5/022; G06F 16/35; G06F 40/35

(57) ABSTRACT

An AI agent system includes an episode memory database configured to accumulate dialogue histories with users as episode memories including a plurality of messages—, a semantic memory construction unit configured to cluster the messages included in the episode memories into a plurality of clusters and extract scenario branches based on transitions of the messages between the clusters, and a semantic memory database configured to store the scenario branches as semantic memories.

### CROSS REFERENCE TO RELATED APPLICATIONS

This application claims priority to Japanese Patent Application No. 2024-232195, filed Dec. 27, 2024, the contents of which are incorporated herein by reference in its entirety for all purposes.

### BACKGROUND OF THE INVENTION

### 1. Field of the Invention

The present invention relates to a knowledge extraction system and a knowledge extraction method.

### 2. Description of the Related Art

Against the backdrop of a declining labor population and labor shortages, task substitution by robots and virtual agents has been progressing. Such agents have traditionally been applied to relatively simple tasks such as transportation, cleaning, and security. However, with the advancement of generative AI (Large Language Models: LLMs), their utilization has been expanding to tasks that require more complex and natural interactions, such as customer guidance and service operations.

In order to cause an AI agent to behave appropriately, adjustments such as prompt engineering are required. However, in cases such as customer guidance in commercial facilities, it is difficult to prepare prompts that can produce suitable responses for a wide variety of user needs.

Non-patent literature 1, Andrew Zhao, Daniel Huang, Quentin Xu, Matthieu Lin, Yong-Jin Liu, Gao Huang, “ExpeL: LLM Agents Are Experiential Learners,” arXiv:2308.10144, Aug. 20, 2023, discloses a technique in which the processes of successful tasks are recorded, and when performing new tasks, those processes can be recalled as concrete examples and referred to. This technique enables high-level insights to be extracted from the experience of past tasks through natural language, allowing application and generalization to new tasks without updating parameters.

### CITATION LIST

### Non-Patent Literature

Non-Patent Literature 1: Andrew Zhao, Daniel Huang, Quentin Xu, Matthieu Lin, Yong-Jin Liu, Gao Huang, “ExpeL: LLM Agents Are Experiential Learners,” arXiv:2308.10144, Aug. 20, 2023

### SUMMARY OF THE INVENTION

However, in Non-patent Literature 1, experiences and insights are managed and retrieved as flat string information, making it difficult to organize and interpret diverse user requests and extract them as usable knowledge. That is, Non-patent Literature 1 is designed for responses to a single user or a specific task, and therefore is not suitable for tasks that involve responding to an unspecified number of users with diverse needs (tasks), such as those encountered in commercial facilities.

In environments such as commercial facilities that require responding to users with diverse demands, it is desirable to realize an AI agent capable of continuously learning response methods through experience and flexibly adapting to various demands, environments, and changing needs.

Accordingly, the present invention aims to provide a technology that enables flexible adaptation to various demands and changes in environments and needs.

To solve the above-described problems, one representative embodiment of the present invention provides a knowledge extraction system that stores experiential memories, comprising:
an episode memory unit that stores a user's dialogue history as episode memories including multiple messages;
a semantic memory construction unit that clusters the messages contained in the episode memories into multiple clusters and extracts scenario branches based on transitions between the clusters of messages; and
a semantic memory unit that stores the extracted scenario branches as semantic memories.

According to the present invention, it is possible to flexibly respond to diverse demands and changes in environments or needs.

Other problems, configurations, and effects not described above will become apparent from the description of embodiments given below.

### BRIEF DESCRIPTION OF THE DRAWINGS

FIG. 1 is a block diagram illustrating an example configuration of an AI agent system to which the knowledge extraction system of the present embodiment is applied.

FIG. 2 is a block diagram illustrating an example hardware configuration of an information processing apparatus to which the knowledge extraction system of the present embodiment is applied.

FIG. 3 is a flowchart illustrating an example of response processing by a user interface unit.

FIG. 4 is a flowchart illustrating an example of prompt generation processing by a memory retrieval unit.

FIG. 5 is a flowchart illustrating an example of semantic memory construction processing by a semantic memory construction unit.

FIG. 6 is a diagram illustrating an example data structure of an episode memory database.

FIG. 7 is a schematic diagram illustrating clustering of messages performed by the semantic memory construction unit.

FIG. 8 is a schematic diagram illustrating extraction of scenario branches performed by the semantic memory construction unit.

FIG. 9 is a diagram illustrating an example data structure of a semantic memory database.

FIG. 10 is a diagram illustrating an example of a standard user interface screen displayed by the user interface unit.

FIG. 11 is a diagram illustrating an example of a standard management interface screen displayed by a management interface unit.

FIG. 12 is a diagram illustrating another example of a standard management interface screen displayed by the management interface unit.

### DESCRIPTION OF THE PREFERRED EMBODIMENTS

Preferred embodiments of the present invention will now be described below with reference to the accompanying drawings.

### Embodiment 1

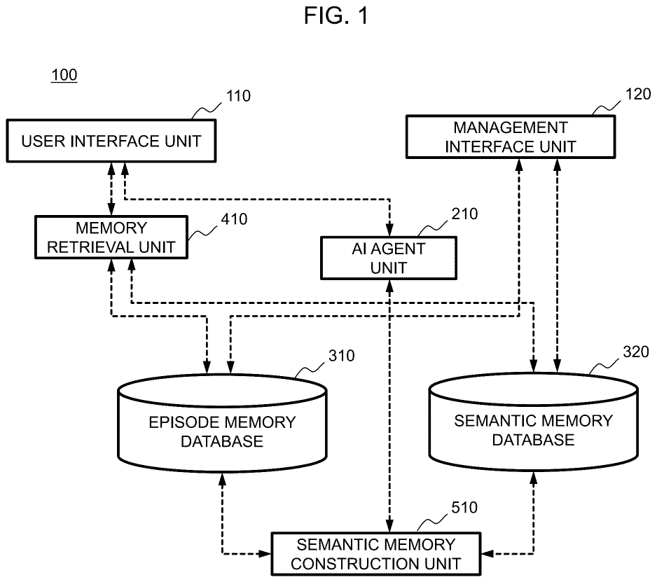

FIG. 1 is a block diagram illustrating an example configuration of an AI agent system to which the knowledge extraction system of the present embodiment is applied. The AI agent system 100 is installed, for example, in a computer, tablet, signage terminal, or robot device. In this embodiment, an example will be described in which the AI agent system is mounted on a device installed in an airport or commercial facility and performs guidance or product explanation through interaction with customers. However, the present invention is not limited to this example.

The AI agent system 100 includes a user interface unit 110, a management interface unit 120, an AI agent unit 210, an episode memory database 310, a semantic memory database 320, a memory retrieval unit 410, and a semantic memory construction unit 510.

The user interface unit 110 includes a graphical user interface (GUI) and provides functions that allow a user to input information to and receive output from the AI agent system 100.

The management interface unit 120 provides functions that enable an administrator of the AI agent system 100 to review, manage, and adjust experiential memories stored in the system as necessary. The experiential memories include episode memories and semantic memories.

The AI agent unit 210 utilizes AI technologies such as a large language model (LLM) to provide AI agent services to users.

The episode memory database 310 (episode memory unit) stores the dialogue history between a user and the system as episode memories. The dialogue history includes user questions and requests, intermediate outputs of the AI agent unit 210, responses to users, and user replies to those responses. In addition to linguistic information, the episode memories also include non-linguistic context information, such as the user's situational conditions (e.g., location, weather, season, time of day) and user attributes (e.g., age, gender, or group composition when multiple users are present).

The context information may be obtained by a camera or sensor provided in the device, or through network communication with an external system. Alternatively, the user may input context information through the GUI, or a user ID may be linked in advance with such context information. The AI agent system 100 can generate more suitable responses for each user based on this context information.

The semantic memory database 320 (semantic memory unit) stores semantic memories constructed based on the episode memories. The semantic memory represents knowledge that is generally applicable to specific use cases or groups of tasks, or even to use cases and tasks in general. Moreover, the semantic memory contains information related to branch structures of conversation scenarios extracted from multiple episodes.

The memory retrieval unit 410 searches and extracts necessary information from the episode memory database 310 and the semantic memory database 320 and generates prompts to be transmitted to the AI agent unit 210 based on the extracted information.

The semantic memory construction unit 510 constructs semantic memories representing more general knowledge based on the episode memories stored in the episode memory database 310. The semantic memories include information used by the AI agent unit 210 to generate scenario branches of the episode memories and narrowing questions.

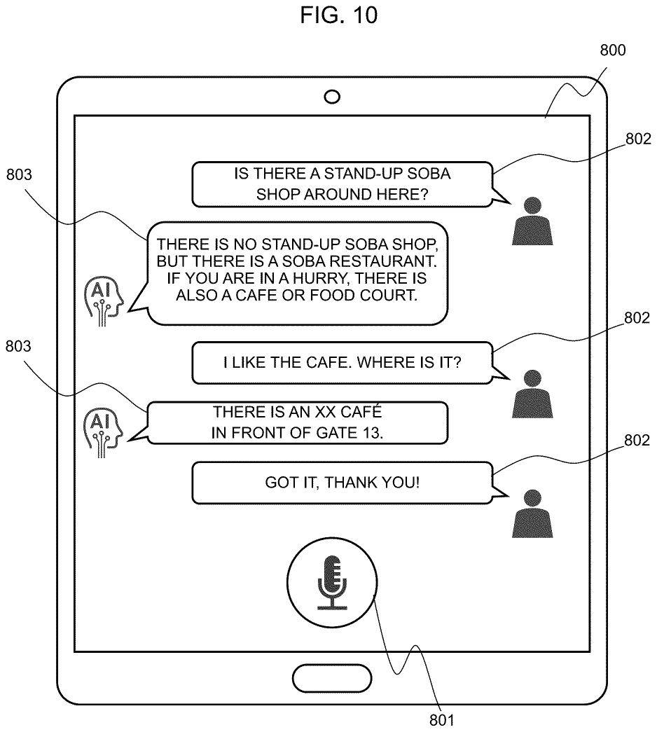

The term scenario branch refers to information indicating how transitions occur between user messages and AI agent unit 210 messages contained in the episode memories. For example, as illustrated in FIG. 10, in a case where the user's message “Are there any standing soba noodle shops?” is responded to by the AI agent unit 210 with “There are authentic soba restaurants,” the episode memory construction process is exemplified. If, in some episode memories, the user then says “I'm in a hurry,” while in others the user says “Please tell me about the authentic soba restaurant,” the semantic memory construction unit 510 extracts this as a scenario branch.

A narrowing question is a question used to narrow down the user's needs in order to provide a response aligned with the user's intent. For example, in the above case, based on the scenario branch, the semantic memory construction unit 510 generates information for the AI agent unit 210 to generate a narrowing question such as “Are you in a hurry, or do you prefer soba noodles?”. Based on this information, the AI agent unit 210 generates a narrowing question in response to the user's message “Are there any standing soba noodle shops?”, such as “Although there are no standing soba restaurants, there are soba restaurants. Alternatively, if you are in a hurry, there are cafés and food courts available.”

Thus, by generating scenario branches and narrowing questions, the AI agent system 100 can estimate the user's latent intent and present options, enabling it to provide information more quickly in accordance with the user's needs.

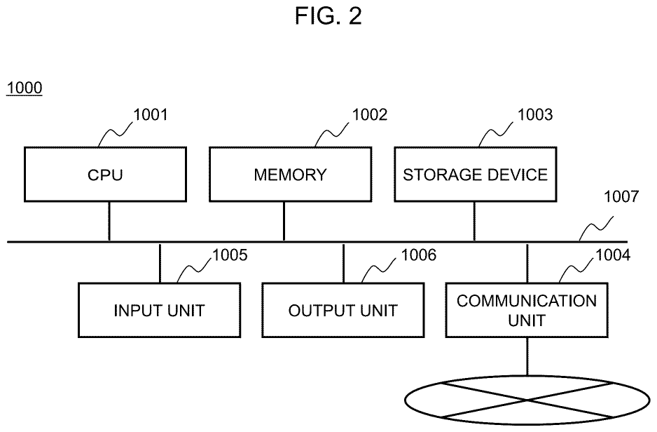

The knowledge extraction system of this embodiment can be implemented, for example, using an information processing apparatus as illustrated in FIG. 2.

FIG. 2 is a block diagram showing an example of the hardware configuration of the information processing apparatus to which the knowledge extraction system of this embodiment is applied.

The user interface unit 110, management interface unit 120, AI agent unit 210, memory retrieval unit 410, and semantic memory construction unit 510 shown in FIG. 1 operate on an information processing apparatus 1000. The information processing apparatus 1000 is a server or computer composed of a CPU (Central Processing Unit) 1001, memory 1002, storage device 1003, communication unit 1004, input unit 1005, and output unit 1006, which are interconnected via an internal communication path 1007.

The CPU 1001 is a central processing unit that implements required functions by executing programs stored in the memory 1002 (or the storage device 1003). The programs include those that realize the user interface unit 110, the management interface unit 120, the AI agent unit 210, the memory retrieval unit 410, and the semantic memory construction unit 510 shown in FIG. 1.

The memory 1002 serves as a main memory used when the CPU 1001 executes processes and is composed of volatile storage devices such as RAM (Random Access Memory).

The storage device 1003 is an auxiliary storage device for storing input data provided to the CPU 1001 and output data generated by the CPU 1001, and is composed of non-volatile storage devices such as SSDs (Solid State Drives). The storage device 1003 also stores data such as the episode memory database 310 and the semantic memory database 320 shown in FIG. 1.

The communication unit 1004 is an interface for the information processing apparatus 1000 to communicate with external devices, and is composed of a network adapter or communication module. The communication unit 1004 connects to a network (for example, the Internet) and performs communication with external devices via the network.

The input unit 1005 is an interface for receiving inputs from an operator or user, and may include a keyboard, touch panel, or voice input device (microphone).

The output unit 1006 is an interface for outputting data to an operator, and may include a display or audio output device (speaker).

The internal communication path 1007 is a communication route for data exchange among the components of the information processing apparatus 1000.

In this embodiment, the user interface unit 110, management interface unit 120, AI agent unit 210, memory retrieval unit 410, and semantic memory construction unit 510 are executed on one or more information processing apparatuses 1000 having the hardware configuration illustrated in FIG. 2, thereby realizing the various processes described below.

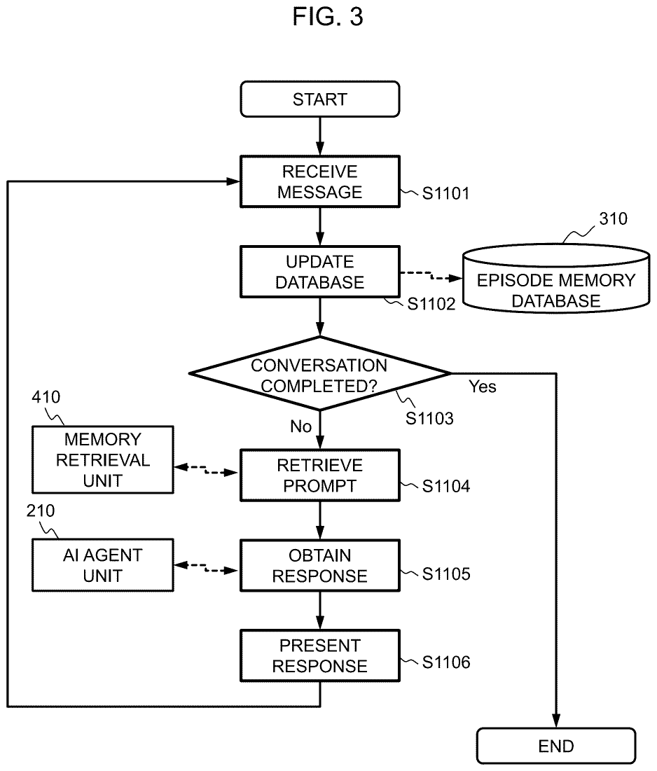

Next, with reference to FIGS. 3 to 5, the processing executed by the knowledge extraction system of this embodiment will be described.

FIG. 3 is a flowchart illustrating an example of response processing performed by the user interface unit 110.

The user interface unit 110 receives a message input by the user in natural language (S1101). The message may be input, for example, by user operation through a standard user interface screen as shown in FIG. 10 described later, or may be input by voice through a microphone.

Thereafter, the user interface unit 110 adds the received message to the episode memory database 310 and performs an updating process (S1102).

Next, the user interface unit 110 determines whether the message from the user includes a keyword indicating completion of interaction (for example, “end process”) or is labeled with data indicating completion of interaction (S1103). If the message from the user includes a keyword or label indicating completion of interaction, this process is terminated.

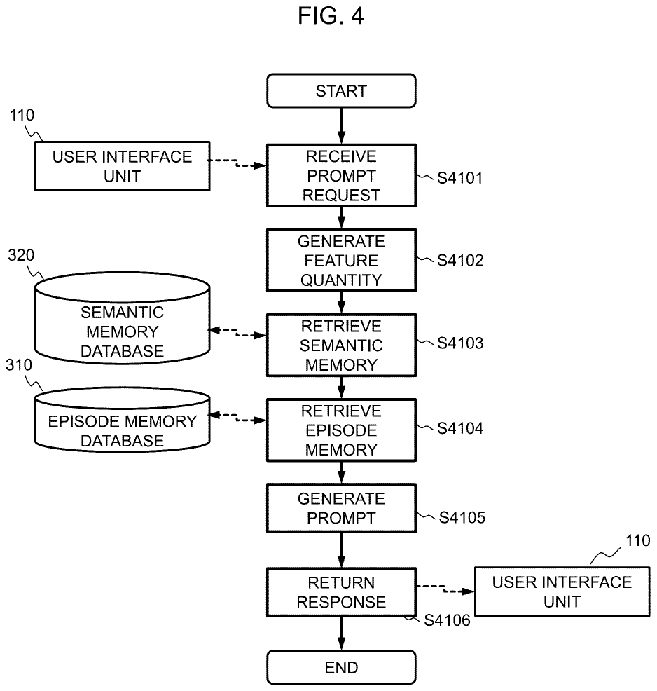

On the other hand, if it is determined in S1103 that the message from the user does not include a keyword or label indicating completion of interaction, the user interface unit 110 accesses the memory retrieval unit 410 and obtains, from the memory retrieval unit 410, a prompt to be provided to the AI agent unit 210 (S1104). This prompt includes samples of past episodes similar to the user's message, as well as instructions for generating narrowing questions. The prompt generation process by the memory retrieval unit 410 will be described later with reference to FIG. 4.

Next, the user interface unit 110 accesses the AI agent unit 210 using the prompt obtained from the memory retrieval unit 410 and obtains from the AI agent unit 210 a response to the user's message (S1105).

Next, the user interface unit 110 presents the response obtained from the AI agent unit 210 to the user (S1106), and then returns to S1101. Here, for example, the user interface unit 110 displays the response obtained from the AI agent unit 210 on the standard user interface screen such as that shown in FIG. 10 described later.

FIG. 4 is a flowchart illustrating an example of prompt generation processing performed by the memory retrieval unit 410.

The memory retrieval unit 410 receives, from the user interface unit 110, a prompt generation request for the AI agent unit 210 (S4101). At this time, the memory retrieval unit 410 also receives, from the user interface unit 110, the user's message associated with the prompt generation request.

Subsequently, the memory retrieval unit 410 generates feature quantities based on the user's message using an embedding model or the like, and converts the message into a format suitable for similarity search (S4102). The generated feature quantities are stored in association with the message in the episode memory database 310.

Next, the memory retrieval unit 410 uses the generated feature quantities to retrieve, from the semantic memory database 320, semantic memories similar to the user's message (S4103). In addition, the memory retrieval unit 410 retrieves, from the episode memory database 310, episode memories of past cases similar to the user's message (S4104).

When searching for experiential memories similar to the user's message, the memory retrieval unit 410 does not perform the search from the beginning of the conversation, but searches backward from conclusions that satisfied the user. This narrows down the search targets for message comparison and reduces computational load.

In addition, messages may be weighted according to the frequency with which a path is traversed during the search. This makes it possible to preferentially narrow down uncertain branches. The frequency of path traversal is updated each time a conversation takes place. The system may also be provided with a function to change message weighting according to user needs.

Next, the memory retrieval unit 410 generates a prompt to be provided to the AI agent unit 210 using the retrieved semantic memories and episode memories (S4105). In this process, the retrieved semantic memories are embedded into the prompt for generating narrowing questions, while the retrieved episode memories are embedded into the prompt as examples of similar cases.

Subsequently, the memory retrieval unit 410 returns the generated prompt to the user interface unit 110 as a response (S4106) and terminates the process.

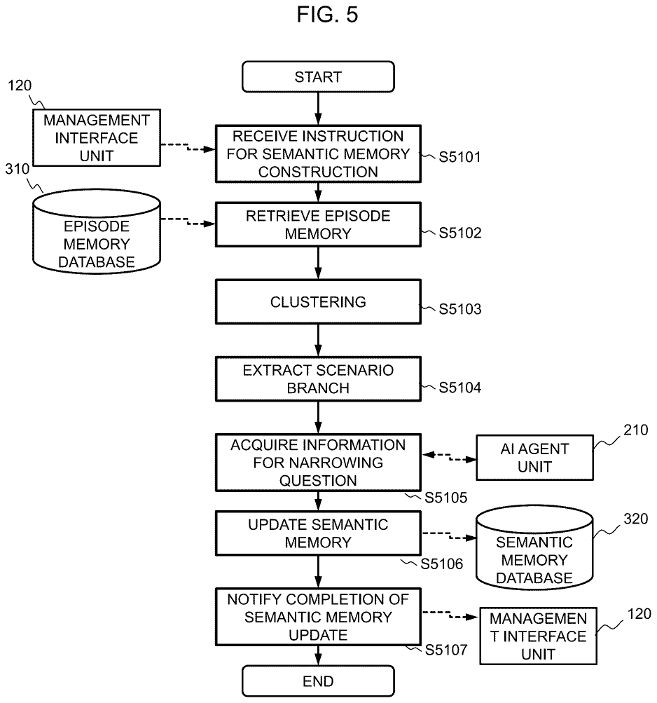

FIG. 5 is a flowchart illustrating an example of semantic memory construction processing performed by the semantic memory construction unit 510. In this process, the semantic memory construction unit 510 constructs semantic memories based on multiple episode memories stored in the episode memory database 310 and registers them in the semantic memory database 320.

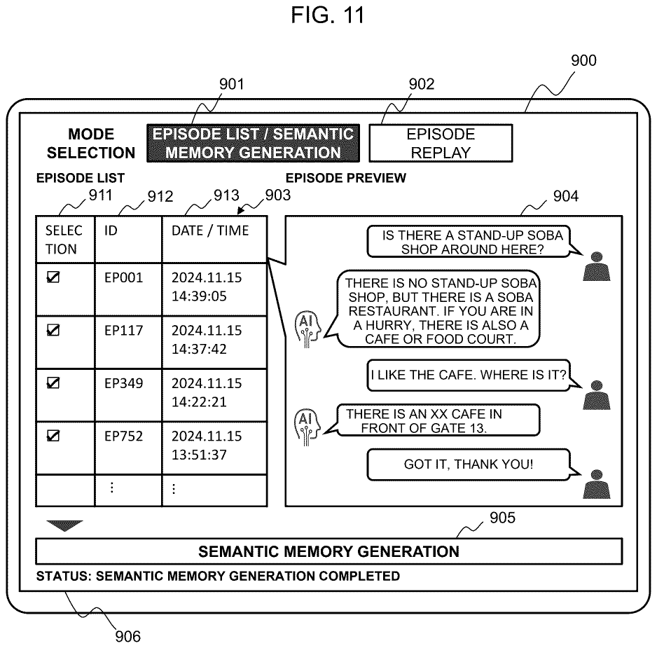

The semantic memory construction unit 510 receives an instruction to construct semantic memories from the management interface unit 120 (S5101). The instruction for constructing semantic memories may be input by a user operation through a standard management interface screen as shown in FIG. 11 described later, or the system may be preset to execute the semantic memory construction process periodically.

Next, the semantic memory construction unit 510 acquires all episode memories from the episode memory database 310 (S5102).

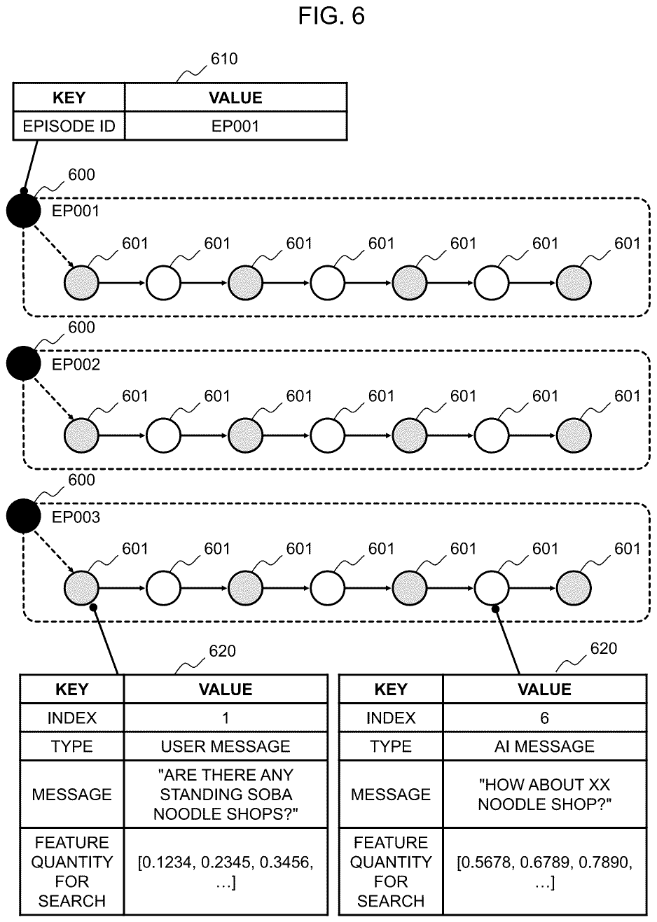

Here, with reference to FIG. 6, the episode memories stored in the episode memory database 310 will be described.

FIG. 6 is a diagram illustrating an example of the data structure of the episode memory database 310. The episode memory database 310 stores natural language messages input by the user through the user interface unit 110 and natural language messages obtained from the AI agent unit 210. Each episode 600 is represented as a graph structure (chain structure) that connects these messages in temporal order. This structure enables storage of a large amount of data representing the context and conversational flow of episodes from a large number of users.

Note that episode memories that have not been used for prompt or response generation may be too individual to be utilized or may lack reproducibility. Therefore, by lowering the importance score of such episode memories, the quality of the episode memory database can be maintained.

Each message node 601 constituting the episode 600 stores one natural language message. By recording messages in detail on a node-by-node basis, the entire dialogue can be preserved. Each episode 600 is assigned a unique episode ID 610, which allows the episode to be uniquely identified.

Each message node 601 has properties 620. The properties 620 include an index, a type, a message, and feature quantities for search.

The index represents the order or positional information of the node. The type indicates the nature of the message (for example, a user's utterance or a response from the AI agent unit 210). The message is the natural language message itself, which records the specific content of the conversation.

The feature quantities for search are used for similarity searches within the episode memory database 310. These feature quantities are numerical data representing the semantics and context of messages, enabling efficient computation of similarities between messages.

Although not shown in the figure, by associating non-linguistic context information with this episode memory graph and applying convolutional features, it becomes possible to perform similar-episode searches and response generation that take such context information into account.

Returning to FIG. 5, in step S5103, the semantic memory construction unit 510 clusters the messages constituting multiple episodes included in the episode memories using the feature quantities for search. In this process, the semantic memory construction unit 510 does not perform clustering by searching for similar messages individually for each message, but performs clustering in a sliding-window manner for several adjacent messages. Furthermore, when traversing adjacent messages, the semantic memory construction unit 510 performs clustering based on movement trajectories and distances in the embedding space.

Even if there is variation in the progress of conversation depending on the user, it is assumed that there is a correlation between the progress of the conversation and the distance between messages. Therefore, when measuring message similarity, the semantic memory construction unit 510 narrows the range of similarity search using the distances between messages, thereby reducing computational load.

As preprocessing before clustering, the semantic memory construction unit 510 performs processing to remove redundant parts of utterances and summarize utterances. In addition, the semantic memory construction unit 510 identifies proper nouns included in the messages, classifies them into abstract categories using a conceptual hierarchy, and generalizes them.

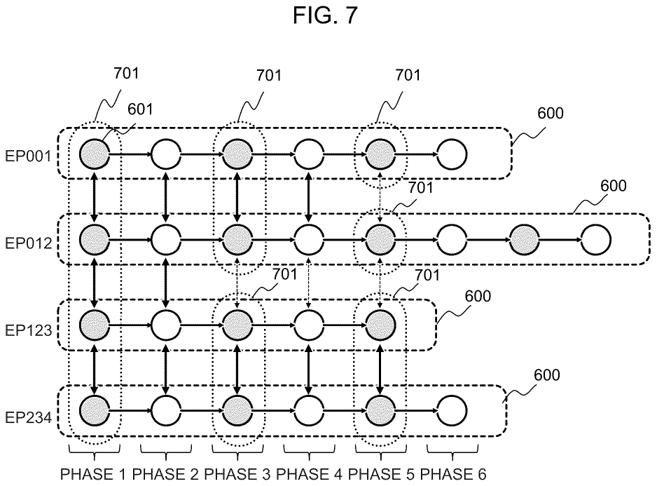

Here, with reference to FIG. 7, clustering of messages will be described.

FIG. 7 is a schematic diagram illustrating message clustering performed by the semantic memory construction unit 510.

Based on the feature quantities for search of the message nodes 601 in multiple episodes 600 stored in the episode memory database 310, the semantic memory construction unit 510 groups message nodes 601 containing semantically similar content as the same cluster, forming a plurality of clusters 701.

Phases 1, 3, and 5 are user messages, while phases 2, 4, and 6 are responses from the AI agent unit 210. In FIG. 7, the semantic memory construction unit 510 clusters the message nodes 601 corresponding to the user messages in phases 1, 3, and 5 and groups them into multiple clusters 701.

In addition to comparing similarities between messages in corresponding phases of multiple episodes, the semantic memory construction unit 510 also compares similarities between messages in adjacent phases and adopts the one with the highest similarity. This enables a more robust similarity search. Furthermore, the semantic memory construction unit 510 may also calculate the similarity between the user's message and the immediately preceding message of the AI agent unit 210, and use a weighted average of these as the message similarity. This makes it possible to calculate a similarity that takes into account the relationship between the user's response and the AI agent unit 210's preceding response.

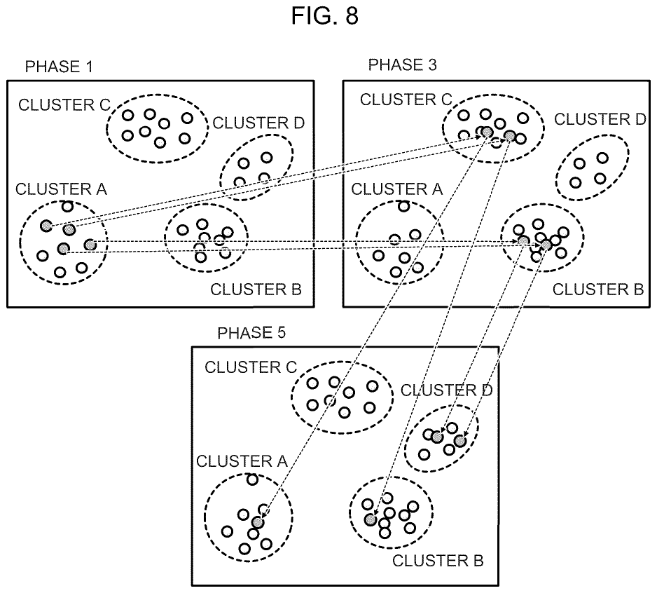

Returning to FIG. 5, in step S5104, the semantic memory construction unit 510 extracts transitions between clusters as scenario branches based on the results of clustering. Here, with reference to FIG. 8, the extraction of scenario branches will be described.

FIG. 8 is a schematic diagram illustrating the extraction of scenario branches performed by the semantic memory construction unit 510. FIG. 8 shows a feature space in which clusters corresponding to phases 1, 3, and 5 exist. In FIG. 8, clusters A to D each contain multiple messages clustered therein.

In this feature space, transitions of messages between clusters are observed. Specifically, the semantic memory construction unit 510 analyzes how conversations progress within and across episodes and what kinds of relationships arise between messages belonging to different clusters.

For example, a message clustered into cluster A in phase 1 transitions to cluster B or cluster C in phase 3. Also, a message clustered into cluster C in phase 3 transitions to cluster A or cluster B in phase 5. In this way, the semantic memory construction unit 510 extracts cases in which messages belonging to the same cluster transition to different clusters as scenario branches and constructs semantic memories.

Further, a message clustered into cluster B in phase 3 transitions to cluster D in phase 5. Although not shown in the figure, there are also cases where messages belonging to different clusters transition to the same cluster. In such cases, scenario branches are not extracted.

The semantic memory construction unit 510 stores the extracted scenario branches in the semantic memory database 320. As a result, the memory retrieval unit 410 can retrieve and extract past scenario branches similar to the user's message from the semantic memory database 320, thereby predicting possible future conversation branches and generating prompts accordingly.

Returning to FIG. 5, in step S5105, the semantic memory construction unit 510 accesses the AI agent unit 210 and acquires information for generating narrowing questions based on the scenario branches. For example, based on a scenario branch in which the user's message “Are there any standing soba noodle shops?” transitions to “I'm in a hurry” or “Please tell me about the authentic soba restaurant,” the semantic memory construction unit 510 generates information such as “confirm whether the user is in a hurry or prefers soba noodles.”

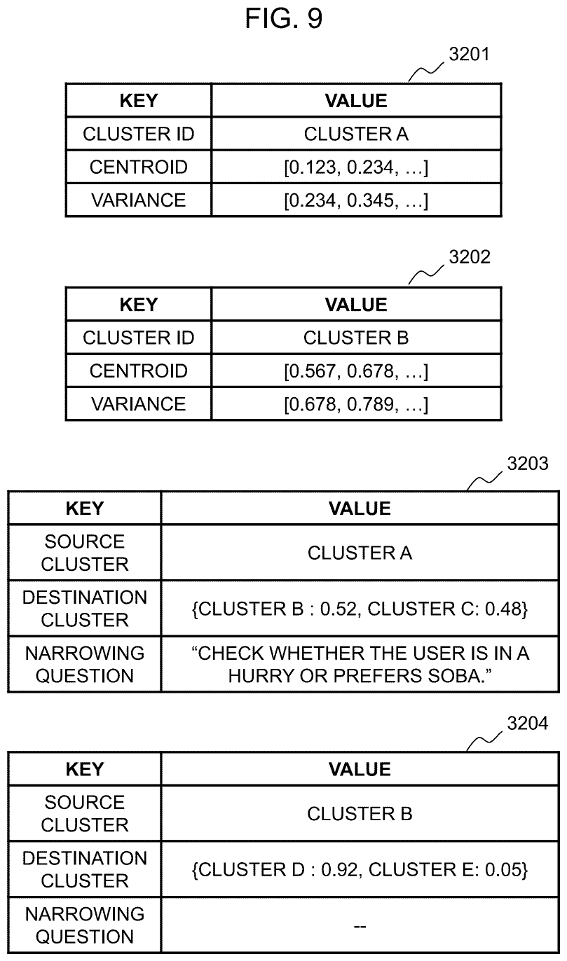

Next, in step S5106, the semantic memory construction unit 510 registers in the semantic memory database 320 the cluster information obtained in step S5103, the scenario branch information extracted in step S5104, and the information for generating narrowing questions acquired in step S5105. Thereafter, the semantic memory construction unit 510 notifies the management interface unit 120 that the semantic memory update process has been completed (S5107) and terminates the process. Here, with reference to FIG. 9, the data structure of the semantic memory database 320 will be described.

FIG. 9 is a diagram illustrating an example of the data structure of the semantic memory database 320. The semantic memory database 320 is used to manage information related to classification and transitions of episode memory messages, and mainly stores information regarding the relationships and transitions between clusters.

The semantic memory database 320 stores two main types of information. One type is information 3201 and 3202 related to each cluster, and the other type is information 3203 and 3204 related to transitions between clusters.

The information 3201 and 3202 related to each cluster includes a cluster ID and data concerning the centroid and variance of each cluster. The centroid and variance represent the distribution of the feature quantities of messages within each cluster. These pieces of information are used to determine which cluster a new user message belongs to.

The information 3203 and 3204 related to transitions between clusters includes the cluster ID of the source cluster, information on the destination clusters, and information related to narrowing questions. The information on the destination clusters includes the cluster IDs of the destination clusters and the transition probabilities to each destination cluster. The information related to narrowing questions includes information used to generate narrowing questions for identifying the destination clusters.

By having the AI agent unit 210 generate narrowing questions based on this information for generating narrowing questions, it becomes possible to estimate the message's destination cluster and quickly arrive at a response that matches the user's needs.

When, as in the case of the transition information 3204 between clusters, there is a bias exceeding a threshold in the transition probabilities toward certain destination clusters, the semantic memory construction unit 510 determines that narrowing questions are unnecessary and does not store the narrowing question information. In such cases, when generating a prompt, the memory retrieval unit 410 skips the branch of the transition information 3204 between clusters and refers to the branch information of the cluster D whose transition probability exceeds the threshold to identify the next narrowing question.

FIG. 10 is a diagram illustrating an example of a standard user interface screen displayed by the user interface unit 110.

The standard user interface screen 800 is displayed on a display provided in a device such as a computer, tablet, signage, or robot equipped with the AI agent system 100.

When the user clicks the microphone icon 801 on the standard screen 800 and then speaks toward the microphone provided in the device, the user interface unit 110 transcribes the spoken content and displays it as utterance content 802 on the standard screen 800.

The user interface unit 110 also acquires a response to the user's utterance content from the AI agent unit 210, displays the response 803 on the standard screen 800, and reads the response aloud through the speaker provided in the device.

FIG. 11 is a diagram illustrating an example of a standard management interface screen displayed by the management interface unit 120.

The standard management interface screen 900 is displayed on a display provided in a device equipped with the AI agent system 100 or on an external device such as a computer or tablet that communicates with the device.

The management interface has two modes: an episode list/semantic memory generation mode and an episode playback mode. Switching between modes on the standard screen 900 is performed by the administrator clicking either “Episode List/Semantic Memory Generation” 901 or “Episode Playback” 902. FIG. 11 shows an example in which the episode list/semantic memory generation mode is selected.

An episode list 903 is displayed on the left side of the standard screen 900, showing a list of episodes stored in the episode memory database 310. The episode list 903 includes a selection field 911 for the administrator to select episodes, an ID field 912 indicating the ID of each episode, and a date-time field 913 indicating the update date and time of each episode.

When the administrator clicks the ID field 912 or the date-time field 913 of any episode, the management interface unit 120 displays the content of the corresponding episode in a preview 904 on the right side of the standard screen 900.

When the administrator selects one or more episodes in the selection field 911 and clicks “Semantic Memory Generation” 905, the semantic memory construction unit 510 starts the semantic memory construction process shown in FIG. 5 and generates semantic memories from the selected episodes. Furthermore, the management interface unit 120 displays the progress of the semantic memory construction process in a status field 906 at the bottom of the standard screen 900. For example, when the semantic memory construction process is completed, the management interface unit 120 displays “Semantic Memory Generation Completed” in the status field 906.

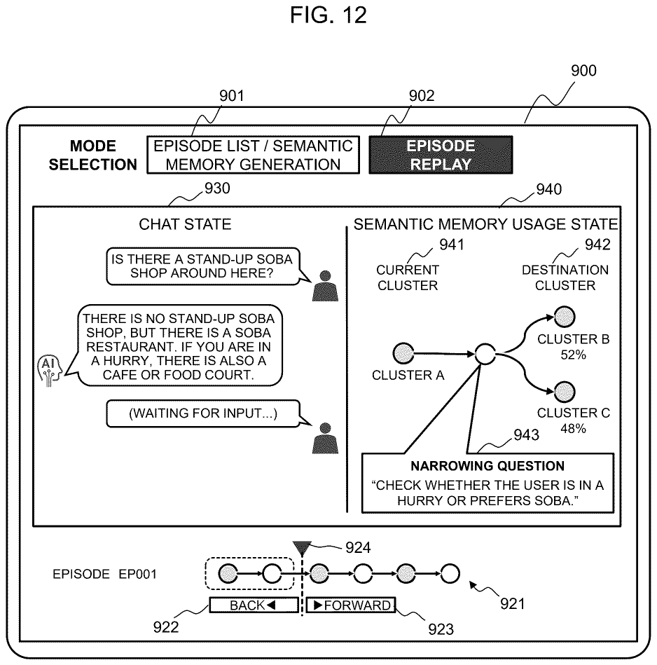

When the administrator clicks “Episode Playback”902, the management interface unit 120 switches the standard screen 900 to the episode playback mode, as shown in FIG. 12.

FIG. 12 is a diagram illustrating an example of a standard management interface screen displayed by the management interface unit 120. FIG. 12 shows an example in which the episode playback mode is selected.

In the episode playback mode, it is possible to check how the semantic memories stored in the semantic memory database 320 were used in the episodes included in the past episode memories stored in the episode memory database 310.

A seek bar 921 is displayed at the bottom of the standard screen 900. The seek bar 921 indicates the transitions of messages within one episode. The administrator can move a cursor 924 by clicking “Back” 922 or “Forward” 923 and select a message for which the state of semantic memory use is to be checked.

The management interface unit 120 displays, in a chat status field 930 at the upper left of the standard screen 900, the chat state before and after the message selected on the seek bar 921.

The management interface unit 120 also displays, in a semantic memory usage status field 940 at the upper right of the standard screen 900, the cluster 941 to which the immediately preceding user message of the selected message on the seek bar 921 belongs in the semantic memory, the cluster 942 that has been determined to be a possible branch destination thereafter, and the related narrowing question 943.

According to this embodiment, scenario branches can be extracted based on numerous accumulated episode memories, and narrowing questions can be generated to estimate the user's unspoken intentions that do not appear in the user's utterances, thereby realizing responses that meet the user's true needs. Furthermore, by continuously learning appropriate response methods to various user requests through experience, it is possible to flexibly adapt to diverse requests and changes in environments and needs.

It should be noted that the present invention is not limited to the embodiments described above and includes various modifications. For example, the above-described embodiments have been described in detail to facilitate understanding of the present invention and are not necessarily limited to configurations including all of the described components. In addition, part of the configuration of one embodiment can be replaced with a configuration of another embodiment, and the configuration of one embodiment can also be added to another embodiment. Furthermore, part of the configuration of each embodiment can be added, deleted, or replaced with other configurations.

What is claimed is:

1. A knowledge extraction system that accumulates experiential memories, comprising:
an episode memory unit configured to accumulate a dialogue history with a user as episode memories including a plurality of messages;
a semantic memory construction unit configured to cluster the messages included in the episode memories into a plurality of clusters and extract scenario branches based on transitions of the messages between the clusters; and
a semantic memory unit configured to store the scenario branches as semantic memories.

2. The knowledge extraction system according to claim 1, further comprising:
a user interface unit configured to receive natural language messages from the user;
a memory retrieval unit configured to search for and acquire the episode memories and the semantic memories similar to the user's message, and generate a prompt based on at least one of the acquired episode memories and semantic memories; and
an AI agent unit,
wherein the user interface unit
acquires, using the prompt, a natural language message responding to the user's message from the AI agent unit, and
presents the message from the AI agent unit to the user.

3. The knowledge extraction system according to claim 2,
wherein the semantic memory construction unit
generates information for causing the AI agent unit to generate narrowing questions presented to the user based on the scenario branches.

4. The knowledge extraction system according to claim 2,
wherein the episode memories stored in the episode memory unit comprise a graph structure in which the messages from the user and the messages from the AI agent unit are linked in temporal order.

5. The knowledge extraction system according to claim 4,
wherein the memory retrieval unit
generates feature quantities obtained by quantifying the meanings and contexts of the messages and stores the feature quantities in association with the messages in the episode memory unit.

6. The knowledge extraction system according to claim 4,
wherein the semantic memory construction unit
calculates similarities between the messages included in the episode memories based on the feature quantities and clusters the messages based on the similarities.

7. The knowledge extraction system according to claim 2,
wherein the episode memories include non-linguistic context information.

8. A knowledge extraction method of a knowledge extraction system that accumulates experiential memories, comprising:
accumulating, by an episode memory unit, a dialogue history with a user as episode memories including a plurality of messages;
clustering, by a semantic memory construction unit, the messages included in the episode memories into a plurality of clusters and extracting scenario branches based on transitions of the messages between the clusters; and
storing, by a semantic memory unit, the scenario branches as semantic memories.
